(19) United States
(12) Patent Application Publication
(10) Pub. No.: US 2006/0224604 A1
(43) Pub. Date: Oct. 5, 2006

(54) Content-descriptive user interface correlation for page navigation systems

(76) Inventors: Richard A. Landsman, Los Altos, CA (US); David Gang, Oakton, VA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/260,450

(22) Filed: Oct. 27, 2005

Related U.S. Application Data
(60) Provisional application No. 60/668,484, filed on Apr. 5, 2005.

(51) Int. Cl. G06F 17/00

(52) U.S. Cl. 707/100

(57) ABSTRACT

The present invention provides for navigation systems for table data structures, and methods for facilitating the locating of information in a table data structure. To generate the navigation system, a sort criteria being used to organize the table data structure is identified. After identifying page delineations in the table data structure, data ranges of each page are identified based on the sort criteria corresponding to each page. The data ranges corresponding to each page are displayed on a graphical user interface to indicate to the user the content of each page.

### CROSS-REFERENCE TO RELATED APPLICATIONS

This application claims priority to and benefit of U.S. Provisional Patent Application Ser. No. 60/688,484, filed Apr. 5, 2005, which application is incorporated by reference herein in its entirety.

### BACKGROUND OF THE INVENTION

1. The Field of the Invention

The present invention relates to systems and methods for organizing information. In particular, the present invention relates to providing a content-descriptive user interface correlation for table data structure navigation systems.

2. The Relevant Technology

A common way to organize information in a data structure is to use a table data structure to display the information to the user on a computer user interface page. Generally, the table information is maintained with columns and rows, with the ability to sort information based on the information in a particular column. As the information in tables becomes more extensive, the table grows to a length that would require a user to scroll down through vast amounts of information. To make viewing the information more manageable, the table is often divided into many separate pages of information. When sorting tables that have extensive amounts of information, the table is visually presented as multiple pages, each page containing sufficient information to approximately fill a standard computer monitor screen, or perhaps a length that can reasonably be scrolled through. The user is generally required to navigate through many pages to get to information later in the table.

Navigation menus typically provide the user with the option to select the first page, the last page, or to scroll to the next or previous page in comparison to the current page being viewed. Alternatively, some navigation menus allow the user to select from a series of numbered selectable links. However, sometimes a user may be searching for information but is unsure on which page that information is located. When tables are on the order of five or more pages, it will be appreciated that the user can spend a large amount of time searching for information, even though the information is sorted according to a particular column identifier.

A common scenario in which data is organized in tables with multiple pages is an email folder, such as an inbox. In interfaces associated with web email applications or desktop e-mail applications, an e-mail folder can easily grow very large. It is often difficult to navigate through a large email folder to find a message of interest because of the size of the folder.

FIG. 1A illustrates one exemplary user interface screen 100 that a user may view for accessing emails in the user's inbox. User interface screen 100 includes a table structure 101 which displays the user's email messages in an organized manner. Table 101 may include a column 102 for identifying the name of a sender, a column 104 for identifying the subject of the email, a column 106 for identifying the date the email was received, a column 108 to indicate the size of the message, a column 110 to indicate whether an attachment was included, a column 112 to indicate the priority of the email, and a column 114 to select whether to delete an email. It will be appreciated that other columns and categories may be added, removed, or reorganized as required or desired.

Generally, in table format, the user will be able to sort email by a particular category or sort criteria. For example, the user can sort by name of sender (column 102), by subject of emails (column 104), by date the email was received (column 106), by size of the email (column 108) and the like. User interface 100 also includes a navigation menu 130 for navigating through pages of the table where the table cannot be conveniently placed on one visual page. In the example of FIG. 1A, table 101 is sorted by the date each email was received (column 106).

Where table 101 extends beyond one visual page, navigation menu 130 provides a means by which a user can select different pages of table 101 to be displayed on user interface screen 100. FIG. 1A illustrates a navigation menu 130 of a style commonly used on many web pages. Menu 130 notifies the user of what item numbers are currently being viewed (in this case, email messages 1-24), and notifies the user of the total number of items in the table (in this example, 145 email messages). Menu 130 also allows the user to cause the next sequential page to be displayed on user interface screen 100 by selecting ‘Older >’, and allows the user to cause the last page of table 101 to be displayed by selecting ‘Oldest >’. If the user is viewing a page other than the first page, menu 130 may also allow the user to select the previous page or the first page of table 101.

When the user is trying to target an email that was sent, for example, on a particular day, it is difficult for a user to determine on which page the information might be found. In the example of FIG. 1A, the user is required to scroll through each page of table 101 one at a time until the user eventually reaches the page being searched for. In each attempt, the user interface updates to actually change the view to show the content of that entire page. Each update of the user interface requires processing time which can further add to the time and aggravation of trying to locate specific content.

Other styles of navigation menus exist, as is illustrated in FIGS. 1B and 1C. For example, FIG. 1B illustrates a navigation menu 132, which is a simplified version of navigation menu 130 of FIG. 1A. Navigation menu 130 only allows the user to select the next sequential page in a table, by selecting the ‘Next>>’ icon.

FIG. 1C illustrates another common navigation menu 134, which provides the user with a series of selectable links, numbered ‘1’ through ‘14’. Each number is a link to a corresponding page of a table. In this example, the user can either scroll through each page sequentially by selecting the ‘Next>>’ button 135, or may go directly to a particular page of the table but selecting a number. For example, if the user selects the link labeled ‘5’, the fifth page of the table will be displayed to the user. Although this style of navigation menu 134 may allow a user to narrow in on the particular page the user is searching for more quickly than the examples of FIGS. 1A and 1B because the user is not required to scroll through each individual page, menu 132 still requires the user to guess which number corresponds to the page the user is searching for until finally finding the page containing the desired data.

FIG. 1D illustrates another common navigation menu 136, which has a number of options for selecting which page of a table to view. For example, the user may go to the page of any item within the table by entering the item number into the box 138. Alternatively, the user may go to the first page in the table by selecting icon 140, scroll to the previous sequential page by selecting icon 142, scroll to the next sequential page by selecting icon 144, or go directly to the last page in the table by selecting icon 146. However, since page identifying information and item identifying information of the prior art do not provide a user any indication of the content of the table data structure, the best a user can do is guess which page or item number he or she is searching for, narrowing in on the exact item or page after each guess.

### BRIEF SUMMARY OF THE INVENTION

The present invention relates to navigation systems and methods for facilitating the location of information in a table data structure. The table data structure may include data tables displayed on a user interface as part of a website, software application, or any other table structure displayed on a user interface. In one embodiment of the invention, the navigation system identifies the sort criteria used to organize a table data structure, and further identifies page delineations in the table data structure. For example, a table displaying email messages may be sorted by date, sender name, subject, and the like. Where a large number of emails exist, the table of emails is often delineated into a number of pages. This is particularly true of web-based email clients.

Once a sort criteria and page delineations are identified, a data range corresponding to each page is identified according to the sort criteria. For example where a table of emails is sorted according to date received, the present invention identifies the ranges of dates of the emails displayed on each page of the table. Finally, the data ranges corresponding to each page are displayed to the user on the graphical user interface in one or more content descriptor fields. The content descriptor fields may be continually updated to reflect any changes that may occur within the table data structure.

In one embodiment of the invention, the page numbers or item numbers associated with each page are also displayed on the graphical user interface. The page numbers, item numbers or content descriptor fields may form selectable links that when selected, causes a corresponding page to be displayed on the graphical user interface.

According to one embodiment of the invention, the content descriptor fields are not displayed on the graphical user interface until the user places an icon, or mouse pointer icon, over a specified area of the graphical user interface, such as, but not limited to, page identifying information areas or item identifying information areas. When the icon is removed from the specified area, the content descriptor field may disappear.

These and other features of the present invention will become more fully apparent from the following description and appended claims, or may be learned by the practice of the invention as set forth hereinafter.

### BRIEF DESCRIPTION OF THE DRAWINGS

To further clarify the above and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-1D illustrate various examples of conventional navigation systems.

FIG. 2 illustrates an exemplary user interface having a table data structure navigable by a page menu and content descriptor data, in accordance with the present invention.

FIG. 2A illustrates an exemplary system block diagram on which the present invention may operate.

FIG. 3 illustrates an exemplary user interface having a table data structure navigable by a content descriptor data, in accordance with the present invention.

FIG. 4 illustrates an exemplary user interface having a table data structure navigable by a page menu and a non-persistent content descriptor data, in accordance with the present invention

### DETAILED DESCRIPTION OF EXEMPLARY EMBODIMENTS

The principles of the present invention relate to navigation systems and methods for facilitating the location of information in a table data structure. The navigation methods include the identification of ranges of data on each page of the table data structure, according to the data used to sort or organize the table data structure. The data ranges are organized and displayed in a manner that allows the user to select which page to view in accordance with the data ranges.

The invention's methods and systems for navigating through table data structures save a user significant time and effort in locating information even where the information is already sorted by a certain criteria. It will be appreciated that the principles of the present invention apply to data navigation systems of any table data structure. However, for purposes of describing the present invention, the following description will reference to an electronic messaging system.

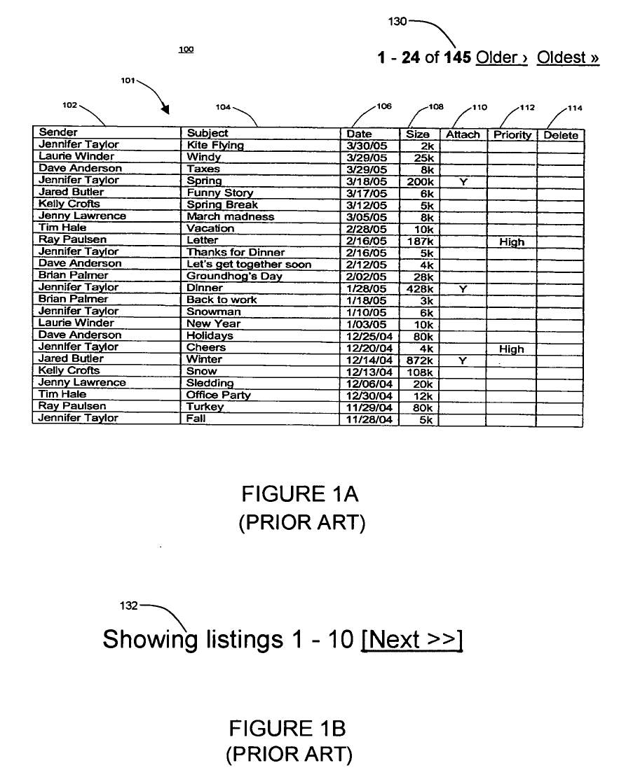

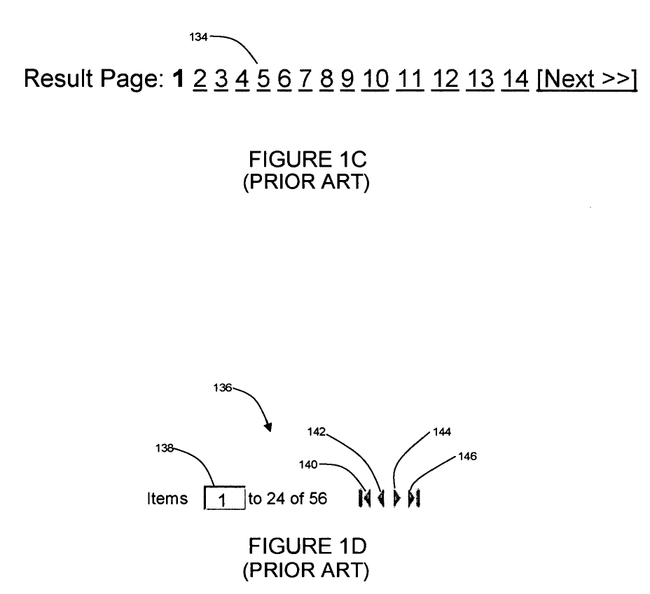

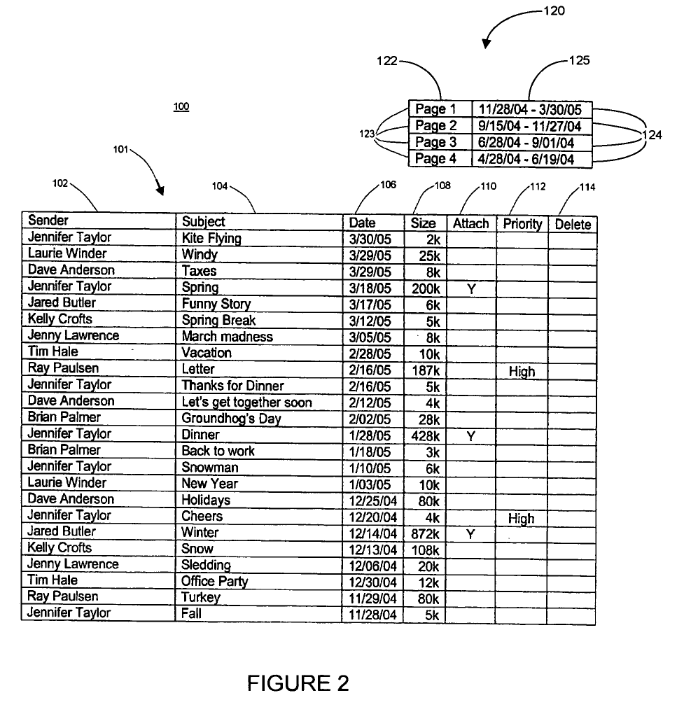

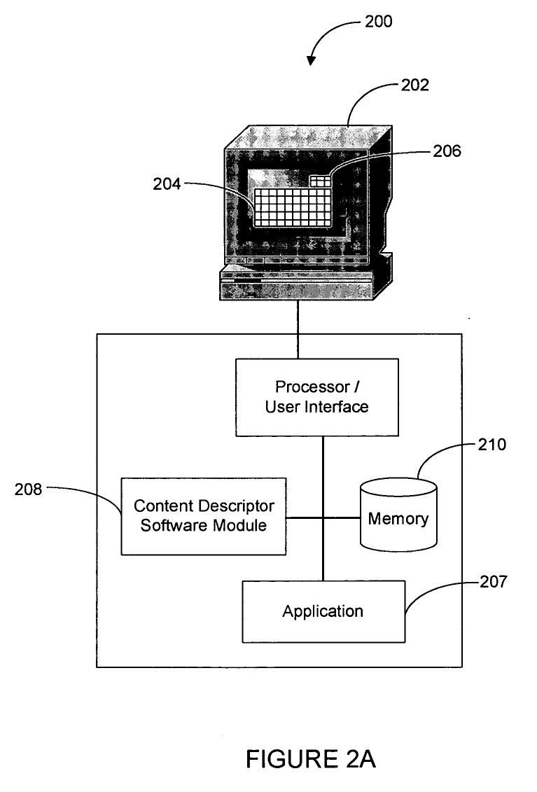

The present invention provides a navigation menu that facilitates the search for a particular item within tables extending beyond one visual page. FIG. 2 illustrates the same table as FIG. 1A, having a navigation menu 120 in accordance with the present invention. Where table 101 extends beyond one visual page, navigation menu 120 provides a page list 122 of page fields 123 identifying each page. When the user clicks on a particular page field 123, the page field 123 corresponds to a certain portion of table 101 and the user interface 100 updates to display that portion of table 101.

Where an extensive number of pages exist, the navigation menu 120 may be formatted into a pull down menu to ease navigation. As used herein, a pull down menu is used in the traditional sense, i.e., a menu of commands or options that appears when the menu is selected with a mouse pointer icon. In this manner, the user can navigate through table 101 which spans multiple pages. The use of a pull down menu also minimizes the space on user interface screen 100 being occupied by navigation menu 120.

Navigation menu 120 also includes a plurality of content descriptor fields 124. Each content descriptor field 124 displays an indicator of the data range that corresponds to the information contained in a particular column by which table 101 is sorted. Thus, by selecting one of the content descriptor fields 124, the graphical user interface can be refreshed to display the portion or page of table 101 corresponding to the selected content descriptor field 124 as identified by the data range indication contained therein. The data range indication thus represents in some manner the range of content contained in a column of table 101. In one embodiment, content descriptor fields 124 can be displayed as a listing, such as the list 126 shown next to page list 122 in navigation menu 120.

Thus, in the embodiment of FIG. 2, the content descriptor fields 124 display date ranges, which corresponds to the manner in which table 101 is sorted. The data range indication in content descriptor fields 124 could also be based on other criteria upon which table 101 can be sorted. As described above, where table 101 is a listing of emails, data ranges in content descriptor fields 124 could be based on the name of senders, subject of emails, size of the emails, and the like. Furthermore, while FIG. 2 depicts complete dates in content descriptor fields 124, it will be appreciated that the data range indication can be abbreviated to reduce the size of the content descriptor fields. In addition, the data range indication can be presented in various formats. For example, a date can be displayed as 11/28/04, November 28, 2004, Nov. 28, 2004, etc.

The present invention updates the data range indication in each content descriptor field 124 each time table 101 is sorted, updated, or refreshed. In other words, navigation menu 120 does not necessarily display predefined values. Instead, because the range of content in each column of the table can vary, navigation menu 120 may be configured to update the values of content descriptor fields 124 every time a data entry is added or deleted from the table 101. Alternatively, navigation menu 120 may be configured to update the data range indication of content descriptor field 124 every time user interface screen 100 is opened or refreshed.

FIG. 2A illustrates a block diagram of a system 200 on which the present invention can operate. System 200 includes a user interface 202 for displaying a table 204 and a navigation menu 206. The table 204 and the navigation menu 206 can be created by an application 207 that is in communication with a content descriptor software module 208 that can be programmed integrally or separately from the application. The content descriptor software module 208 is provided for enhancing the sorting features of the application with the content descriptor features of the module 208 . A processor/user interface 212 is provided for executing the instructions provided by content descriptor software module 208, and for controlling the content displayed on the user interface 202. A memory 210 is also provided for storing data relevant to application 207 and content descriptor software module 208.

When table 204 is sorted, content descriptor module 208 identifies beginning and ends of the pages that will be shown visually on the user interface. In one embodiment, application 207 may have already marked the beginning and end of each page. Content descriptor module 208 locates the entry at the beginning and end of each page. Content descriptor module 208 then identifies a column that was used to sort the table. Content descriptor module 208 parses the beginning and end field for the sort category. Content descriptor module 208 can then identify the data range for each visual page for the sorted column. In creating a data range indication for each page, exemplarily, content descriptor module 208 may create a string of characters to provide a data range indication of the sorted column of each page. Accordingly, a certain data range will be generated for each page, the data range depending on what criteria was used to sort table 101 and the data at the beginning/end of the page. Advantageously, content descriptor module 208 can use the same markers that are used to indicate the beginning and end of each individual page to easily identify the beginning and end of the sort category column for each page.

Referring again to FIG. 2, the content descriptor fields 124 are correlated to page fields 123 of navigation menu 120 so that the user is able to see the data range indication relating to each page to facilitate navigation. In the embodiment shown in FIG. 2, page list 122, showing each page field 123, is located immediately to the left of a descriptor list 125 of the corresponding content descriptor fields 124. In FIG. 2, each page field 123 is displayed next to each content descriptor field 124 so that when the user views page list 122, the user will also see the corresponding descriptor list 125. For example, as shown in FIG. 2, content descriptor field 124 includes date ranges that correspond with each page so that a user can easily target a message that was sent between a certain date range. It will be appreciated that in the embodiment of FIG. 2, since page list 122 is essentially in a table format, the content descriptor fields 124 of descriptor list 125 can be easily displayed as an additional table column in navigation menu 120. Thus, as shown in FIG. 2, page field 123 containing page descriptor “Page 1” correlates with messages received from Nov. 28, 2004 to Mar. 30, 2005 as reflected by data range indicator “11/28/04-3/30/05” in a corresponding content descriptor field 124, and so on for each page field 123. As will be appreciated, by providing a content descriptor field 124 having a data range indication for information contained in a sorted table column and correlating the data range indication to the page on which it is located, it will be easier for a user to search and navigate through the navigation menu 120.

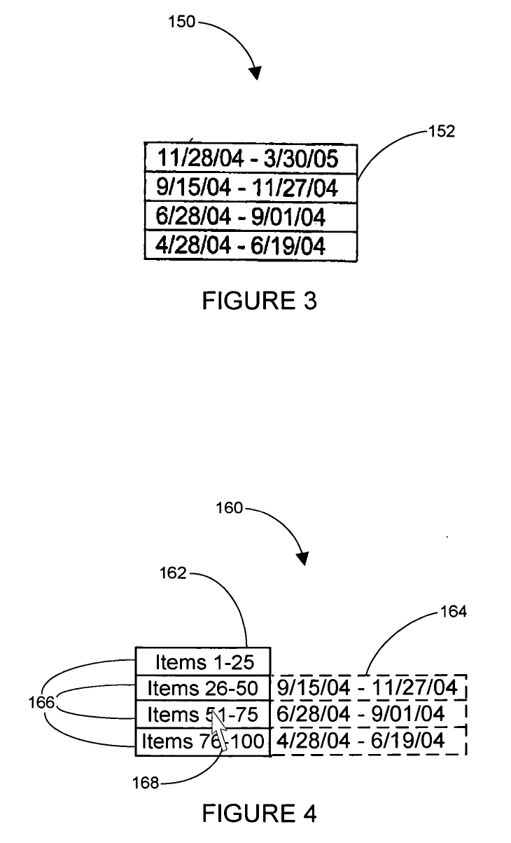

The correlation between page fields 123 and content descriptor fields 124 can be displayed in other manners. In another embodiment, illustrated in FIG. 3, navigation menu 150 consists of only content descriptor fields 152 without displaying a corresponding page number. Therefore, the user is offered the choice of selecting among content descriptor fields 152, without necessarily knowing the exact page number to which the selected content descriptor field corresponds. When the user selects one of the content descriptor fields 152, the corresponding page of table 101 containing the selected data range is generated on user interface screen 100, in a similar manner as the above embodiments. Navigation menu 150 of the present embodiment has the advantage of occupying less area on user interface screen 100 at the expense of not explicitly informing the user of which page number each content descriptor field 152 corresponds to. However, although the user may not necessarily know the exact page number he or she is selecting, the user is often more interested in what data range is being selected rather than the exact page number to which the data range corresponds.

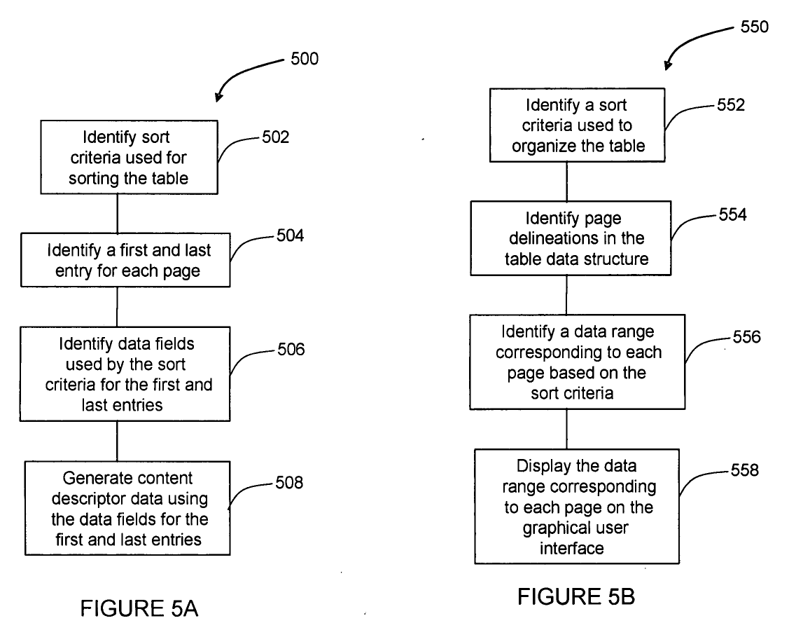

In another embodiment, as illustrated in FIG. 4, each content descriptor field 164 is not readily visible until the user places an icon over part of the navigation menu 160. The embodiment of FIG. 4 illustrates that the navigation menu 160 can include an item list 162 instead of a page list. Thus, the concepts of “pages” can apply equally well to “items” and vice versa. The item list 162 can include one or more item fields 166, each item field 166 corresponding to a portion of the table 101. The item field 166 thus displays the items that are located in that portion of the table 101. It will be appreciated that while table 101 has been described as being divided into a plurality of visual pages, that the term “pages,” is used as a term of convenience to refer to a portion of the table that can conveniently be displayed on a graphical user interface. However, the term “page” may refer to a portion of table 101 that may be displayed inconveniently (e.g., using a scroll bar) to view the page. In any case, the term “page” and portion are used interchangeably herein and the term page is not limited to any certain number of items contained in a portion of a table.

In this embodiment, instead of continually displaying the content descriptor fields 164 on the navigation menu 160, the data ranges of content descriptor fields 164 are only displayed when the user places its icon on an item field 166. The ability of the content descriptor fields 164 to appear and disappear is depicted by the dashed lines surrounding each content descriptor field 164.

For example, the content descriptor fields 164 may be formed from a nonpersistent graphical field that can appear next to item list 162 anytime the icon 168 is placed over one of the item fields 166 of item list 162. The nonpersistent graphical field disappears when the icon 168 is not hovering over any part of item list 162. The content descriptor module 208 (FIG. 2A) thus monitors when an icon hovers over any part of item list 162 and then causes all of the content descriptor fields 164 to be displayed. This embodiment may be advantageous because the user is allowed to see all of the data ranges of content descriptor fields 164 any time the icon 168 is placed anywhere over item list 162, and can quickly navigate to the correct portion of table 101 by selecting the item field 166 corresponding to the desired data range.

Alternatively, multiple nonpersistent graphical fields may exist, each containing one data range of content descriptor field 164. When the icon is placed over an item field 166, the nonpersistent graphical field containing the corresponding data range may appear near the item field 166. The nonpersistent graphical field disappears when the icon is not hovering over the item field 166. Thus, in the example of FIG. 4, if an icon 168 is placed over the ‘Items 51-75’ item field 166 of item list 162, the nonpersistent graphical field containing the data range of ‘6/28/04-9/01/04’ is displayed. The content descriptor module 208 (FIG. 2A) thus monitors when an item field 166 is identified by a mouse or pointer icon icon, identifies a corresponding data range in content descriptor field 164, and then displays the corresponding data range.

Similarly, instead of only displaying the one data range corresponding to the item field 166 over which the icon is hovering, a series of data ranges may be displayed that are in close proximity to one another. For example, if a table includes ten pages of information, and the user places the icon over page field number five, the data ranges corresponding to page fields four, five, and six may appear. In this manner, the user not only discovers the data range for the page field over which the icon is placed, but also discovers the data ranges for other adjacent pages.

The latter two embodiments may be advantageous where it is desirable to reduce the amount of information on the user interface 100. However, these embodiments may be slightly less efficient than the previous embodiments, where the content descriptor field list 125 is either permanently displayed (like in FIG. 2) or entirely appears when the icon is placed over any part of page or item list, since the latter embodiments require the user to place an icon over a specific item or page field to display any data range. However, where a large table exists with a potentially large number of pages or displayed portions, the inefficiency is largely eliminated, since in the embodiment of FIG. 2, with a large table, the content descriptor fields of the later pages might only accessible by scrolling down the navigation menu 120 anyway.

The concept of causing content descriptor field 164 to appear or be displayed according to the foregoing embodiments may be applied to any navigation system. For example, the above-described concepts can be applied to any of the prior art navigation systems of FIGS. 1A through 1D. Likewise, similar embodiments may be derived for displaying data ranges for virtually any other style of navigation system.

In one embodiment of the invention, the principles described herein are implemented by the web developer of a website so that a navigation menu taught herein is displayed to by all users who visit the website. However, the principles of the present invention do not necessarily need to be implemented by the original web developer. Instead, a software application may be configured to create a navigation menu in accordance with the present invention on any webpage having a sortable table data structure consisting of multiple pages using a servlet, an applet, or an application residing on a server or a client computer. When a webpage is loaded, the software application scrapes the webpage to determine if the webpage contains a table data structure. If so, the software determines the sort criteria by which the table is sorted. As described above, a navigation menu is generated, consisting of the data ranges of each page within the table, in accordance with the sort criteria. The software application alters the display of the webpage to include a navigation menu according to one of the embodiments described herein. If the webpage already had an existing navigation menu, the existing navigation may be altered or replaced by the navigation menu created by the software application. In one embodiment, the user can select between an enhanced navigation menu having content descriptor fields or a conventional navigation menu without content description.

Many webpages and software packages other than email may benefit from the content of the present invention. For example, real estate listing websites can be searched and sorted by many different criteria, including price, square footage, number of bedrooms, garage size, year built, and the like. Often, a user enters broad search criteria, such as $100,000 to $200,000, only to find an unreasonably large number of search results. Because of the large number of results, the user subsequently decides to only look at houses between 2,000 and 2,500 square feet. After re-sorting the results according to square footage, under current navigation systems, the user typically randomly selects page numbers or sequentially scrolls through each individual page until finally narrowing in on the houses having the desired square footage. The present invention facilitates the location of houses having the desired square footage by displaying the range of square footage that is contained within each page of the results table.

While the above examples have focused on web-based applications such as email, the present invention is not limited to web-based applications. Instead, the present invention can be beneficial if implemented on any software program that creates sorted table data structures of multiple pages, including search engines, where navigating the table would be simplified by supplying data ranges corresponding to each page.

The present invention may also be described in terms of methods. The following is a description of methods that may be preformed in practicing the present invention.

FIGS. 5A and 5B illustrate flow diagrams for various exemplary embodiments of the present invention. The following description of FIGS. 5A and 5B will occasionally refer to corresponding elements from FIGS. 2-4. Although reference may be made to a specific element from these figures, such elements are used for illustrative purposes only and are not meant to limit or otherwise narrow the scope of the present invention unless explicitly

FIG. 5A illustrates a flow diagram for a method 500 of generating a navigation system for facilitating navigation of a table data structure. Method 500 includes, at 502, identifying a sort criteria used for sorting the table data structure. For example, in the email table data structure of FIG. 2, the table was sorted by date, thus the sort criteria in this case was the date that each email was received. As described above, the sort criteria may be any datan item by which the table was sorted.

Method 500 also includes, at 504, identifying a first and last entry among the plurality of entries for the at least one page or portion of the table. For example, in the email data structure table of FIG. 2, the method identifies the first entry for the page shown as the email sent by Jennifer Taylor with the subject line “Kite Flying”, and the last entry as the email sent by Jennifer table with the subject line “Fall.” Where multiple pages exist, the same act may be performed for all pages.

Method 500 also includes, at 506, identifying data fields used by the sort criteria for the first and last entries for the at least one page. Therefore, to continue with the current example of FIG. 2, the sort criteria was the date which each email was sent. Consequently, the method identifies “3/30/05” and “11/28/04” as the data fields used by the sort criteria for the first and last entries of the page shown. Again, where multiple pages exist, the same act may be performed for all pages, thus acquiring data fields for the first and last data entries of each page, in accordance with the sort criteria.

Method 500 also includes, at 508, generating content descriptor data for describing the content of the at least one page using the content of the data fields for the first and last entries of the at least one page, wherein the content descriptor data is configured to be viewable by the user. Therefore, in the present example of FIG. 2, method 500 generates content descriptor field 124, using data fields for the first entry (i.e., “3/30/05”) and the last entry (i.e., “11/28/04”). Where multiple pages exist, the same act may be performed for all pages, and therefore, the generated content descriptor data may include multiple content descriptor fields describing the data on each page. Although FIG. 2 is provided by way of example, method 500 is not limited to the generation of a content descriptor data field having the appearance of content descriptor field 124. Instead, method 500 may generate any content descriptor data that describes the content of a page of a table data structure according to the sorted criteria.

Although the content descriptor data of method 500 is “viewable” by a user, the content descriptor data does not necessarily immediately displayed to the user. In other embodiments, however, method 500 also includes displaying the content descriptor data on the computer user interface, and may further include displaying page or item field so that the content descriptor data is associated with corresponding page numbers or item numbers. By way of example, FIG. 2 provides a navigation menu 120 where both page list 122 and content descriptor list 124 are displayed. The page fields 123 of page list 122 are visually associated with content descriptor fields 124 of content descriptor list 125 with a one-to-one correspondence. In yet another embodiment, method 500 may include displaying a content descriptor field when a pointer icon is placed over or hovers over a page field. For example, the dotted line surrounding content descriptor field 164 of FIG. 4 illustrates one embodiment where content descriptor field 164 appears when a pointer icon is placed over item field 162. Similarly, method 500 may further include erasing the content descriptor field when the pointer icon is removed from the page field.

In one embodiment of method 500, either the content descriptor fields, the page fields, or both, may be selectable to view pages of the table data structure that correspond to the selected link.

In another embodiment of method 500, the content of the content descriptor fields is updated when a change occurs to the entries of the table data structure. Therefore, the content descriptor fields always display accurate information regarding the content of each page of the table data structure to the user.

FIG. 5B illustrates a flow diagram for a method 550 of providing content descriptive correlations for a navigation system. Method 550 includes, at 552, identifying a sort criteria being used to organize a table data structure. Method 550 also includes, at 554, identifying page delineations in the table data structure. Method 550 also includes, at 556, identifying a data range corresponding to each page based on the sort criteria. Method 550 also includes, at 557, displaying the data range corresponding to each page on the graphical user interface.

Embodiments of the invention include or are incorporated in computer-readable media having computer-executable instructions or data structures stored thereon. Examples of computer-readable media include RAM, ROM, EEPROM, CD-ROM or other optical disk storage, magnetic disk storage or other magnetic storage devices, or any other medium capable of storing instructions or data structures and capable of being accessed by a general purpose or special purpose computer. Computer-readable media also encompasses combinations of the foregoing structures. Computer-executable instructions comprise, for example, instructions and data that cause a general purpose computer, special purpose computer, or special purpose processing device to execute a certain function or group of functions. The computer-executable instructions and associated data structures represent an example of program code means for executing the steps of the invention disclosed herein.

The invention further extends to computer systems adapted for use with adapted for use with user interfaces that operate as described herein. Those skilled in the art will understand that the invention may be practiced in computing environments with many types of computer system configurations, including personal computers, multi-processor systems, network PCs, minicomputers, mainframe computers, and the like. The invention will be described herein in reference to a distributed computing environment, such as the Internet, where tasks are performed by remote processing devices that are linked through a communications network. In the distributed computing environment, computer-executable instructions and program modules for performing the features of the invention may be located in both local and remote memory storage devices.

The present invention may be embodied in other specific forms without departing from its spirit or essential characteristics. The described embodiments are to be considered in all respects only as illustrative and not restrictive. The following exemplary claim is presented to illustrate various novel features of the present invention. The claim is not exhaustive of the embodiments of the invention, nor is it to be construed as limiting the scope of the invention. Moreover, the invention disclosed in detail herein can be defined with other claims, including those that will be included in any related non-provisional applications that will be filed during the pendency of this provisional application.

What is claimed is:

1. In a table data structure implementing a navigation system, the navigation system being displayed in a graphical user interface, a method for providing content descriptive correlations for the navigation system comprising:
identifying a sort criteria being used to organize a table data structure;
identifying one or more page delineations in the table data structure;
identifying a data range corresponding to at least one page based on the sort criteria; and
displaying the data range corresponding to at least one page on the graphical user interface.

2. The method as recited in claim 1, further comprising displaying at least one of page identifying information or item identifying information of the at least one page together with the displayed data range.

3. The method as recited in claim 1, wherein the displayed data range is a selectable link that, when selected, causes the at least one page to be displayed on the graphical user interface.

4. The method as recited in claim 2, wherein at least one of the page identifying information or item identifying information is a selectable link that, when selected, causes the at least one page to be displayed on the graphical user interface.

5. The method as recited in claim 1, further comprising displaying the data range comprises displaying a pull-down menu on the graphical user interface, the pull-down menu containing the displayed data range.

6. The method as recited in claim 1, wherein displaying the data range comprises displaying the data range on the graphical user interface when a pointer icon is placed over a specified area of the graphical user interface.

7. The method as recited in claim 2, wherein displaying the data range comprises displaying the data range on the graphical user interface when a pointer icon is placed over at least one of the page identifying information or item identifying information displayed on the graphical user interface.

8. The method as recited in claim 6, further comprising erasing the displayed data range when the pointer icon is removed from the specified area of the graphical user interface.

9. The method as recited in claim 7, further comprising erasing the displayed data range when the pointer icon is removed from over the at least one of the page identifying information or the item identifying information.

10. The method as recited in claim 1, further comprising updating the data range based on the sort criteria when a change occurs to the table data structure.

11. A method for assisting a computer user to identify a desired page within a table data structure having one or more pages, each page having a plurality of entries and configured to be displayed on a computer user interface, the method comprising:
identifying a sort criteria used for sorting the table data structure;
identifying a first and last entry among the plurality of entries corresponding to each page;
identifying the sort criteria data fields in the first and last entry for each page; and
generating at least one content descriptor field based on content in the sort criteria data fields in the first and last entry for each page, the at least one content descriptor field describing the content of one of the pages of the table data structure.

12. The method as recited in claim 11, further comprising displaying the at least one content descriptor field on the computer user interface.

13. The method as recited in claim 12, further comprising displaying at least one of page identifying information or item identifying information corresponding to the same page as the at least one content descriptor field.

14. The method as recited in claim 11, wherein the at least one content descriptor field forms a selectable link that, when selected, causes the corresponding page to be displayed on the graphical user interface.

15. The method as recited in claim 13, wherein at least one of the page identifying information or the item identifying information forms a selectable link that, when selected, causes the corresponding page to be displayed on the graphical user interface.

16. The method as recited in claim 12, wherein displaying the at least one content descriptor field comprises displaying a pull-down menu on the computer user interface, the pull-down menu containing the at least one content descriptor field.

17. The method as recited in claim 12, wherein displaying the at least one content descriptor field comprises displaying the at least one content descriptor field on the computer user interface when a pointer icon is placed over a specified area of the computer user interface.

18. The method as recited in claim 13, wherein displaying the at least one content descriptor field comprises displaying the at least one content descriptor field on the computer user interface when a pointer icon is placed over at least one of the page identifying information or item identifying information displayed on the computer user interface.

19. The method as recited in claim 11, further comprising updating the at least one content descriptor field based on the sort criteria when a change occurs to the table data structure.

20. In a computer, a computer program product for generating a navigation system for facilitating navigation of a table data structure, the computer program product comprising one or more computer readable media having stored thereon computer executable instructions that, when executed by a processor, can cause the computer to perform the following:
identifying a table data structure;
identifying a navigation menu corresponding to the table data structure;
identifying a sort criteria used for sorting the table;
identifying one or more page delineations in the table data structure;
identifying a data range corresponding to at least one page based on the sort criteria; and
modifying the user interface to enhance the navigation menu to display at least the data range for the at least one page on the graphical user interface.

21. The computer readable medium of claim 20, wherein modifying the user interface comprises displaying at least the data range in a list of data ranges.

22. The computer readable medium of claim 20, wherein modifying the user interface comprises displaying at least the data range next to page identifying information.

23. The computer readable medium of claim 20, wherein modifying the user interface comprises displaying at least the data range next to item identifying information.

24. The computer readable medium of claim 20, wherein the computer program product is executed at a client and the navigation menu is generated by an application being executed at a server.

25. The computer readable medium of claim 20, wherein the computer program is executed at a server and the navigation menu is generated by an application being executed at a server.

26. The computer readable medium of claim 20, wherein the computer program is executed at a client and the navigation menu is generated by an application being executed at a client.
